(19) United States
(12) Patent Application Publication
(10) Pub. No.: US 2006/0182865 A1
(43) Pub. Date: Aug. 17, 2006

(54) Ultra low fat, dry fry process of making donuts

(76) Inventor: Frank Dilullo, Brooklyn, NY (US)

Correspondence Address: MEREDITH & KEYHANI, PLLC, 330 MADISON AVE., 6TH FLOOR, NEW YORK, NY, 10017, US

(21) Appl. No.: 11/059,011

(22) Filed: Feb. 16, 2005

(51) Int. Cl. A21D 10/04

(52) U.S. Cl. 426/552

(57) ABSTRACT

The present invention provide a process of an ultra low fat donut. The process comprising of the steps of: providing batter comprising enriched wheat flour bleached, a fast-acting leavening agent and soy flour; handcutting the batter into donut pieces between 1.3 and 1.7 ounces; proofing the donut pieces and baking the pieces in a deck or convection oven.

### BACKGROUND OF THE INVENTION

The present invention generally relates to baked goods and more specifically to processes for “baking” donuts.

Diets high in fat are known to cause obesity, which can cause a variety of health problems including heart disease. Various health groups have recommended that individuals reduce the fat intake in their diet. However, many low fat and reduced products do not taste as good as their full fat counterparts. There is a constant search for methods and ingredients to provide lower fat baked goods that taste the same as the original fried goods.

Donuts generally fall into two broad categories: cake donuts, leavened by a baking powder chemical reaction which produces carbon dioxide, and yeast-raised donuts, leavened by yeast enzymes which react with sugar during fermentation to produce carbon dioxide and ethyl alcohol. Conventional cake donuts are prepared from a batter which is deposited into hot oil for frying. Yeast-raised donuts are produced from a dough which is permitted to ferment before being fried in hot oil.

U.S. Pat. No. 5,232,721 discloses coating foodstuffs with an edible polymer, such as a protein, modified protein, carbohydrate or modified carbohydrate to form a continuous coating that functions as a barrier that minimizes the uptake of the frying fats.

U.S. Pat. No. 5,464,642 discloses a process of making reduced fat fried snacks with lighted structures than conventional dough based fried snacks. The reduced fat fried snacks are produced from a sheetable dough which contains calcium carbonate, starch-based flour, hydrolyzed starches, emulsifiers and water.

U.S. Pat. No. 5,804,243 discloses a low-fat, chemically-leavened cake donut that is prepared by formulating a self-sustaining, soft (low modulus) dough which contains from 20-30% of a thermally-reversible, fiber-containing gel, forming the dough into donut-shaped pieces and baking the dough pieces. The process requires a high moisture content.

Also known are donuts with methylcellulose and HPMC. In one study, entitled “Reduced Fat Uptake and Increased Moisture Retention in Yeast-leavened Donuts with Methylcellulose and HPMC” reported by D. A. Bell and L. W. Steinke at the Poster Session, American Association of Cereal Chemists (AACC) Annual Meeting, Minneapolis, Minn. 1995, experiments were conducted using donut batters containing 1% powdered hydroxypropylmethylcellulose (HPMC). The fat content of the finished fried donut formed from the batter having HPMC was reported to be significantly less than the finished fried donut formed from a control batter. Oil reductions of 27% were also achieved in fried donuts containing HPMC and methylcellulose.

Another study entitled “Effects of Protein from Different Sources on the Characteristics of Sponge Cakes, Rice Cakes, Doughnuts and Frying Batters” reported in the Journal of the Science of Food and Agriculture 68(3) 271-277 1995, discloses adding soy flour to cake donut formulas to reduce fat absorption during frying. The donuts containing soy flour had reduced oil absorption compared to the control donuts.

While the prior art all provide lower fat donuts and baked goods, the present invention provides an ultra low fat yeast based donut that tastes nearly identical to the conventional fried donut, as opposed to prior art donuts and baked goods that taste dry and undesirable. Further, as opposed to many prior art attempts to provide lower fat donuts, the present invention does not use chemicals to achieve the low fat characteristics of a yeast-raised donut.

### SUMMARY OF THE INVENTION

The present invention provides an ultra low fat, yeast based donut that is the first to be baked rather than fried.

According to the first embodiment of the present invention, A process of making a ultra low fat donut, the process comprising of the steps of: providing batter comprising enriched wheat flour bleached, a fast-acting leavening agent and soy flour; handcutting the batter into donut pieces, wherein the donut pieces are between 1.3 and 1.7 ounces; proofing said donut pieces and baking the donut pieces in a convection oven.

According to a second embodiment of the present invention, a process of making an ultra low fat donut is disclosed, said the process comprising of the steps of: providing batter comprising enriched wheat flour bleached, a fast-acting leavening agent and soy flour; handcutting the batter into donut pieces, wherein the donut pieces are between 1.4 and 1.6 ounces; proofing the donut pieces and baking the pieces in a convection oven.

According to a yet another embodiment of the present invention, A process of making an ultra low fat donut, the process comprising of the steps of: providing batter comprising enriched wheat flour bleached, soybean oil dextrose, dry whey, salt, leavening sodium acid pyrophosphate, baking soda, soy flour, mono & diglycerides with BHT and citric acids as preservatives, sodium stearoyl lactylate, guar gum, wheat starch, corn oil, beta carotene as color 091404(J,D,L).; handcutting the batter into donut pieces, wherein the donut pieces are between 1.4 and 1.6 ounces; proofing said donut pieces and baking the pieces in an oven between 360 and 380 degrees for a time period between 3 and 6 minutes.

This summary is not to be taken in a limiting sense, but is made merely for the purpose of illustrating the general principles of the invention, since the scope of the invention is best defined by the appended claims.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a process of making an ultra low fat donut. Whereas prior art donuts have been able to reduce the fat content from the typical 20 grams of a fried donut, to between 9 and 12 grams with a low fat donut, the present invention provides an ultra low fat donut with between 4 and 5 grams of fat. The process comprises the steps of: providing batter comprising enriched wheat flour bleached, a fast-acting leavening agent and soy flour; handcutting the batter into donut pieces, wherein the donut pieces are between 1.3 and 1.7 ounces, preferably 1.5 ounces; proofing the donut pieces and baking the pieces in a deck oven. The step of proofing the donut pieces may be done in a proof box. The fast acting leavening agent may be leavening sodium acid pyrophosphate. The batter may also have soybean oil dextrose, dry whey, salt, baking soda, mono & diglycerides with BHT and citric acids as preservatives, sodium stearoyl lactylate, guar gum, wheat starch, corn oil and/or beta carotene as color 091404(J,D,L). The deck oven may be steamless. An example of a steamless oven is Miwe Aero Convection Oven. The donut pieces may be baked at between 360 and 380 degrees for a time period between 3 and 6 minutes, preferably the donut pieces are baked at approximately 375 degrees for a time period between 4 and 5 minutes.

The process may further comprise the step of: glazing the donut with a glaze. The glaze may be sugar, chocolate, vanilla, strawberry, lemon, and/or blueberry. The process may also comprise the step of: injecting the donut with a filling. The filling may be Bavarian crème, apple-raspberry, blueberry pie, strawberry pie, lemon and black raspberry.

According to another embodiment, a process of making an ultra low fat donut is envisioned comprising of the steps of: providing batter comprising enriched wheat flour bleached, a fast-acting leavening agent and soy flour; handcutting the batter into donut pieces, wherein the donut pieces are between 1.4 and 1.6 ounces; proofing the donut pieces and baking the donut pieces in a convection oven. The donut pieces are preferably 1.5 ounces.

Again, the fast acting leavening agent may be leavening sodium acid pyrophosphate and the batter may be further comprised of soybean oil dextrose, dry whey, salt, baking soda, mono & diglycerides with BHT and citric acids as preservatives, sodium stearoyl lactylate, guar gum, wheat starch, corn oil, beta carotene as color 091404(J,D,L).

The step of baking the pieces may consist of baking the pieces between 360 and 380 degrees for a time period between 3 and 6 minutes, preferably baking the pieces at approximately 375 degrees for a time period between 4 and 5 minutes.

The process may further comprise the steps of glazing the donut with a glaze. The glaze may be sugar, chocolate, vanilla, strawberry, lemon and blueberry. The process may further comprise the step of: injecting the donut with a filling, wherein the filling may be Bavarian crème, apple-raspberry, blueberry pie, strawberry pie, lemon and black raspberry.

According to yet another embodiment, a process of making an ultra low fat donut is disclosed, comprising of the steps of: providing batter comprising enriched wheat flour bleached, soybean oil dextrose, dry whey, salt, leavening sodium acid pyrophosphate, baking soda, soy flour, mono & diglycerides with BHT and citric acids as preservatives, sodium stearoyl lactylate, guar gum, wheat starch, corn oil, beta carotene as color 091404(J,D,L).; handcutting the batter into donut pieces, wherein the donut pieces are between 1.4 and 1.6 ounces, preferably 1.5 ounces; proofing the donut pieces and baking the pieces in an oven between 360 and 380 degrees for a time period between 3 and 6 minutes in a convection oven, deck oven, or steamless deck oven. The pieces may be baked at approximately 375 degrees for a time period between 4 and 5 minutes.

It should be understood, of course, that the foregoing relates to preferred embodiments of the invention and that modifications may be made without departing from the spirit and scope of the invention as set forth in the following claims.

I claim:

1. A process of making a ultra low fat donut, said process comprising the steps of:
providing batter comprising enriched wheat flour bleached, a fast-acting leavening agent and soy flour;
handcutting said batter into donut pieces, wherein said donut pieces are between 1.3 and 1.7 ounces;
proofing said donut pieces; and
baking said donut pieces in a convection oven.

2. A process as in claim 1, wherein said fast acting leavening agent is leavening sodium acid pyrophosphate.

3. A process as in claim 1, wherein said batter is further comprised of soybean oil dextrose, dry whey, salt, baking soda, mono & diglycerides with BHT and citric acids as preservatives, sodium stearoyl lactylate, guar gum, wheat starch, corn oil, beta carotene as color 091404(J,D,L).

4. A process as in claim 1, wherein said deck oven is steamless.

5. A process as in claim 1, wherein said pieces are 1.5 ounces.

6. A process as in claim 1, wherein said step of baking said pieces consists of baking said pieces between 360 and 380 degrees for a time period between 3 and 6 minutes.

7. A process as in claim 1, wherein said step of baking said pieces consists of baking said pieces at approximately 375 degrees for a time period between 4 and 5 minutes.

8. A process as in claim 1, further comprising the step of:
glazing said donut with a glaze.

9. A process as in claim 8, wherein said glaze is selected from the group comprising of sugar, chocolate, vanilla, strawberry, lemon, blueberry.

10. A process as in claim 1, further comprising the step of:
injecting said donut with a filling.

11. A process as in claim 10, wherein said filling is selected from the group comprising of Bavarian crème, apple-raspberry, blueberry pie, strawberry pie, lemon and black raspberry.

12. A process of making an ultra low fat donut, said process comprising the steps of:
providing batter comprising enriched wheat flour bleached, a fast-acting leavening agent and soy flour;
handcutting said batter into donut pieces, wherein said donut pieces are between 1.4 and 1.6 ounces;
proofing said donut pieces; and
baking said pieces in a convection oven

13. A process as in claim 12, wherein said fast acting leavening agent is leavening sodium acid pyrophosphate.

14. A process as in claim 12, wherein said batter is further comprised of soybean oil dextrose, dry whey, salt, baking soda, mono & diglycerides with BHT and citric acids as preservatives, sodium stearoyl lactylate, guar gum, wheat starch, corn oil, beta carotene as color 091404(J,D,L).

15. A process as in claim 12, wherein said pieces are 1.5 ounces.

16. A process as in claim 12, wherein said step of baking said pieces consists of baking said pieces between 360 and 380 degrees for a time period between 3 and 6 minutes.

17. A process as in claim 12, wherein said step of baking said pieces consists of baking said pieces at approximately 375 degrees for a time period between 4 and 5 minutes.

18. A process as in claim 12, further comprising the step of:
glazing said donut with a glaze.

19. A process as in claim 12, wherein said glaze is selected from the group comprising of sugar, chocolate, vanilla, strawberry, lemon, blueberry.

20. A process as in claim 12, further comprising the step of:
Injecting said donut with a filling.

21. A process as in claim 12, wherein said filling is selected from the group comprising of Bavarian crème, apple-raspberry, blueberry pie, strawberry pie, lemon and black raspberry.

22. A process of making an ultra low fat donut, said process comprising the steps of:
providing batter comprising enriched wheat flour bleached, soybean oil dextrose, dry whey, salt, leavening sodium acid pyrophosphate, baking soda, soy flour, mono & diglycerides with BHT and citric acids as preservatives, sodium stearoyl lactylate, guar gum, wheat starch, corn oil, beta carotene as color 091404(J,D,L).;
handcutting said batter into donut pieces, wherein said donut pieces are between 1.4 and 1.6 ounces;
proofing said donut pieces; and
baking said pieces in an oven between 360 and 380 degrees for a time period between 3 and 6 minutes.

23. A process as in claim 22, wherein said oven is selected from the group comprising of convection oven, deck oven, or steamless deck oven.

24. A process as in claim 22, wherein said pieces are 1.5 ounces.

26. A process as in claim 22, wherein said step of baking said pieces consists of baking said pieces at approximately 375 degrees for a time period between 4 and 5 minutes.
